(19) United States
(12) Patent Application Publication
(10) Pub. No.: US 2026/0200353 A1
(43) Pub. Date: Jul. 16, 2026

(54) CUSTOMER CONFIGURABLE ELECTRIC VEHICLE CHARGER USER INTERFACE

(71) Applicant: Siemens Industry, Inc., Alpharetta, GA (US)

(72) Inventors: Daniel Feldman, New York, NY (US); Thomas Köhler, Leipzig (DE); Swen Gediga, Höchstadt/Aisch (DE); Fabian Lang, Homburg (DE)

(73) Assignee: Siemens Industry, Inc., Alpharetta, GA (US)

(21) Appl. No.: 19/017,975

(22) Filed: Jan. 13, 2025

(51) Int. Cl. B60L 53/30; B60L 53/68; G06F 3/0484

(52) U.S. Cl. CPC B60L 53/305; B60L 53/68; G06F 3/0484; B60L 2250/16

(57) ABSTRACT

An Electric Vehicle (EV) charger or electric vehicle supply equipment (EVSE) comprises one or more electric vehicle supply equipment (EVSE) display screens, one or more Light Emitting Diodes (LEDs), a processor and a memory storing machine executable instructions. The machine executable instructions when executed by the processor, cause the processor to perform operations, the operations comprise: lighting the screens and LEDs. A customer configurable electric vehicle supply equipment (EVSE) user interface as an application (App) runs on a cellphone or a WebApp that runs on a server, which allows a customer to generate an EV charger configuration file that includes images loaded into different EVSE display screens, as well as to configure the behavior (colors, blinking rate, intensity) of the LEDs present at the EV charger or the EVSE.

### BACKGROUND

### Field

Aspects of the present disclosure generally relate to a user interface of a customer configurable electric vehicle charger.

### Description of the Related Art

Charging Point Operators (CPOs) deploying Electric Vehicle Supply Equipment (EVSE) normally prefer to customize the EVSE to include CPO-specific imagines/logos on any screen the EVSE may have, and the color and behavior of LEDs on the EVSE, which help drivers identify the status of a charger and the branding of the CPO from far away and close by.

The process of customizing images and illumination is not-automated, and does not allow customers to preview how a change would look like before it takes place in a customer controlled environment.

Currently EVSE suppliers may offer custom communication to the CPO allowing the CPO backend to load images via a custom API, but without a mechanism to allow the customer to preview how the images will look like virtually. There is also no mechanism to configure LEDs/illumination behavior in EV chargers.

Therefore, a platform that allows remote simulation and configuration of a charger User Interface is needed.

### SUMMARY

Briefly described, aspects of the present disclosure relate to a platform that allows remote simulation and configuration of a charger User Interface. A customer configurable EVSE User interface is an App that can run on a cellphone or a webapp that runs on a server, which allows the customer to generate an EV charger configuration file that includes images loaded into different EVSE screens, as well as to configure the behavior (colors, blinking rate, intensity) of LEDs present at the EVSE. The App/Web App allows a customer to: a) create a target configuration, b) simulate the look and feel of each screen on the charger with the relevant customer images, and c) save the target configuration as a real charger configuration for a Customer Group. The real charger configuration is then loaded into the Customer Group in an EVSE management system, and loaded into all chargers that are associated to this system. A custom configuration message is then sent to all EVSEs at the relevant group by the EVSE management system, ensuring that all EVSEs have the proper configuration of images and LED behavior. On the EVSE itself, the images and LED configurations are applied. This solution implements a control mechanism to make their custom visualization accessible and prevent them from creating broken experiences. Colors and contrasts of fore- and background will be checked to have at least a ratio of 1:4.5 (WCGA AA standards). The solution allows visualization/simulation of changes before they take effect and allows the customer to load these changes in a self-service manner directly into chargers in the relevant controlled groups, allowing customers to differentiate and possibly rebrand, without any manual interaction, and without custom firmware. Accordingly, a platform allows remote simulation and configuration of a charger User Interface that would be directly applied to a charger.

In accordance with one illustrative embodiment of the present disclosure, an Electric Vehicle (EV) charger or electric vehicle supply equipment (EVSE) comprises one or more electric vehicle supply equipment (EVSE) display screens, one or more Light Emitting Diodes (LEDs), a processor and a memory storing machine executable instructions. The machine executable instructions when executed by the processor, cause the processor to perform operations, the operations comprise: lighting the screens and LEDs. A customer configurable electric vehicle supply equipment (EVSE) user interface as an application (App) runs on a cellphone or a WebApp that runs on a server, which allows a customer to generate an EV charger configuration file that includes images loaded into different EVSE display screens, as well as to configure the behavior (colors, blinking rate, intensity) of the LEDs present at the EV charger or the EVSE.

In accordance with one illustrative embodiment of the present disclosure, a method of providing an Electric Vehicle (EV) charger or electric vehicle supply equipment (EVSE) comprises: providing one or more electric vehicle supply equipment (EVSE) display screens, providing one or more Light Emitting Diodes (LEDs), providing a processor and providing a memory storing machine executable instructions. The machine executable instructions when executed by the processor, cause the processor to perform operations, the operations comprising: lighting the screens and LEDs. A customer configurable electric vehicle supply equipment (EVSE) user interface as an application (App) runs on a cellphone or a Web App runs on a server, which allows a customer to generate an EV charger configuration file that includes images loaded into different EVSE display screens, as well as to configure the behavior (colors, blinking rate, intensity) of the LEDs present at the EV charger or the EVSE.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 illustrates a platform that allows remote simulation and configuration of a charger User Interface such that a customer configurable EVSE User interface is an App that can run on a cellphone or a WebApp that runs on a server, which allows a customer to generate an EV charger configuration file that includes images loaded into different EVSE screens, as well as to configure the behavior (colors, blinking rate, intensity) of LEDs present at the EVSE in accordance with an embodiment of the present disclosure.

FIG. 2 shows a flow chart for a method of providing an Electric Vehicle (EV) charger or electric vehicle supply equipment (EVSE) with a platform that allows remote simulation and configuration of a charger User Interface according to an embodiment of the present disclosure.

### DETAILED DESCRIPTION

Various technologies pertain to a platform that allows remote simulation and configuration of a charger User Interface. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

To facilitate an understanding of embodiments, principles, and features of the present disclosure, they are explained hereinafter with reference to implementation in illustrative embodiments. In particular, they are described in the context of a platform that allows remote simulation and configuration of a charger User Interface. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

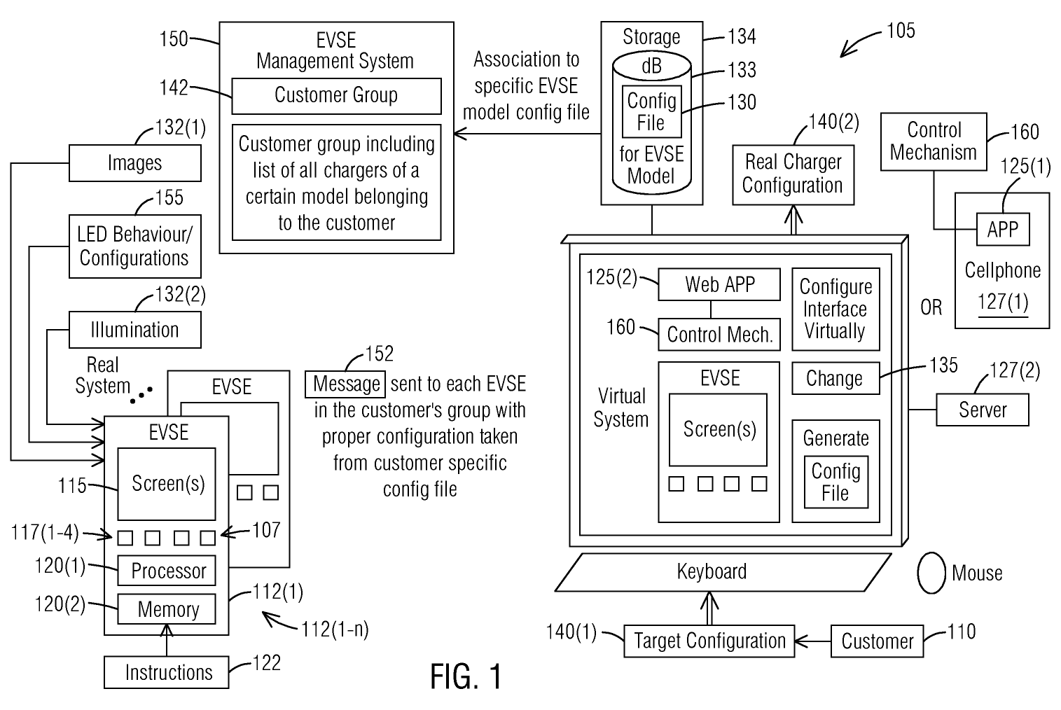

These and other embodiments of the system are provided for a platform that allows remote simulation and configuration of a charger User Interface according to the present disclosure are described below with reference to FIG. 1 herein. The drawing is not necessarily drawn to scale.

Consistent with an embodiment of the present disclosure, FIG. 1 represents a platform 105 that allows remote simulation and configuration of a charger User Interface 107. The platform 105 allows visualization/simulation of changes before they take effect and allows a customer 110 to load these changes in self-service manner directly into EV chargers/EVSEs 112(1-n) in relevant controlled groups, allowing customers to differentiate and possibly rebrand, without any manual interaction, and without custom firmware. Theplatform 105 allows remote simulation and configuration of the charger user interface 107 that would be directly applied to an EV charger/EVSE 112(1).

The Electric Vehicle (EV) charger or electric vehicle supply equipment (EVSE) 112(1) comprises one or more electric vehicle supply equipment (EVSE) display screen(s) 115 and one or more Light Emitting Diodes (LEDs) 117(1-4). The EV charger/EVSE 112(1) further comprises a processor 120(1) and a memory 120(2) storing machine executable instructions 122. The machine executable instructions 122 when executed by the processor 120(1), cause the processor 120(1) to perform operations comprising: lighting the screens 115 and the LEDs117(1-4). A customer configurable electric vehicle supply equipment (EVSE) user interface 107 as an application (App) 125(1) runs on a cellphone 127(1) or as a WebApp 125(2) runs on a server 127(2), which allows the customer 110 to generate an EV charger configuration file 130 that includes images 132(1) loaded into different EVSE display screens, as well as to configure the behavior (colors, blinking rate, intensity) of the LEDs 117(1-4) present at the EV charger or the EVSE 112(1).

The process of customizing the images 132(1) and illumination 132(2) is automated and allows customers 110 to preview how a change 135 would look like before it takes place in a customer-controlled environment of the EV charger/EVSE 112(1). In other words, a mechanism is provided to allow the customer 110 to preview how the images 132(1) will look like virtually and also a mechanism is provided to configure the LEDs/illumination 132(2) behavior in the Electric Vehicle (EV) charger or electric vehicle supply equipment (EVSE) 112(1). The EV charger configuration file 130 for an EVSE model is stored in a database (dB) 133 of a storage 134.

The App 125(1)/WebApp 125(2) allows the customer 110 to: a) create a target configuration 140(1), b) simulate the look and feel of each screen on the EV charger 112(1) with relevant customer images, and c) save the target configuration 140(1) as a real charger configuration 140(2) for a customer group 142. The real charger configuration 140(2) is then loaded into the customer group 142 in an EVSE management system 150 and loaded into all EV chargers/EVSEs 112(1-n) that are associated to the EVSE management system 150.

A custom configuration message 152 is then sent to all the EV chargers/EVSEs 112(1-n) at a relevant group by the EVSE management system 150, ensuring that all the EV chargers/EVSEs 112(1-n) have a proper configuration of images 132(1) and LED behavior/configurations 155. On the EV charger/EVSE 112(1) itself, the images 132(1) and the LED behavior/configurations 155 are applied. A control mechanism 160 makes their custom visualization accessible and prevent them from creating broken experiences such that colors and contrasts of foreground and background will be checked to have at least a ratio of 1:4.5 (WCGA AA standards).

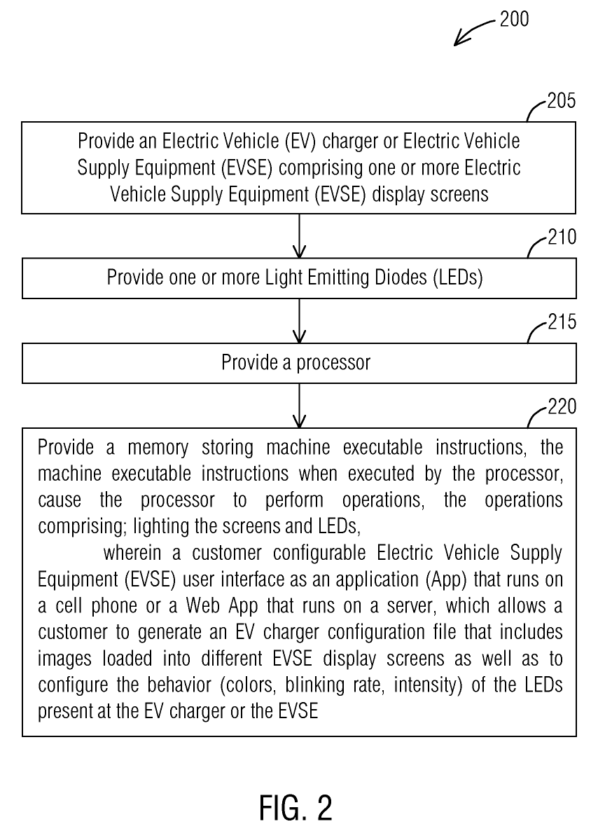

Referring to FIG. 2, it illustrates a flow chart of a method 200 of providing the Electric Vehicle (EV) charger or electric vehicle supply equipment (EVSE) 112(1) with the platform 105 that allows remote simulation and configuration of the charger User Interface 107 in accordance with an embodiment of the present disclosure. Reference is made to the elements and features described in FIG. 1. It should be appreciated that some steps are not required to be performed in any particular order, and that some steps are optional.

The method 200 comprises a step 205 of providing an Electric Vehicle (EV) charger or electric vehicle supply equipment (EVSE) comprising one or more electric vehicle supply equipment (EVSE) display screens. The method 200 further comprises a step 210 of providing one or more Light Emitting Diodes (LEDs). The method 200 further comprises a step 215 of providing a processor and the method 200 further comprises a step 220 of providing a memory storing machine executable instructions. The machine executable instructions when executed by the processor, cause the processor to perform operations. The operations comprising: lighting the screens and LEDs. A customer configurable electric vehicle supply equipment (EVSE) user interface as an application (App) runs on a cellphone or a WebApp that runs on a server, which allows a customer to generate an EV charger configuration file that includes images loaded into different EVSE display screens, as well as to configure the behavior (colors, blinking rate, intensity) of the LEDs present at the EV charger or the EVSE.

An application is a software that lets you exchange information with customers and help them complete specific tasks. Different types of applications, or apps, are based on their development method and internal functionality. Web apps are delivered over an internet browser. Users don't need to install them on their devices. Native apps, on the other hand, are built for a specific platform or device type. The user must install the appropriate software version on their device of choice. Hybrid apps are native applications with a web browser embedded inside them.

Mobile apps are designed to run on a cellphone, while webapps run on a server and are accessed through a web browser. Designed for mobile use, and are installed from an app store. They can be accessed offline, and are usually faster to browse than webapps. A "webapp" is a type of application designed to be accessed through a web browser on any device with an internet connection, meaning it doesn't need to be installed on the user's device; unlike a mobile app which is specifically built for a particular operating system like Android or iOS and needs to be downloaded from an app store.

A web application is a program stored on a remote server and delivered to the user via a browser. Similar to a website, but not entirely. A website is content displayed to the user and is not meant for interactions. The purpose of websites is to display static content to the user—for example, portfolios, official websites of brands, etc. Web application, however, is intended for interaction between the user and the application. To explain it more clearly, let’s take a social media platform like Instagram. What will you usually do on Instagram? You scroll through various posts and reels, send messages to your friends, and share your day. These activities are the interactions from your side with the web application. This usually is not possible on websites. Hence the difference.

One of the unique aspects of web applications that differentiate them from mobile applications is that it does not need to be installed as a separate application on the desktop and can be accessed via browser in the following way: The user sends a query to the web server through a browser using the internet. After receiving the request, the server prepares to deliver the requested request. The requested information later sends results from the web application server to the server. The web server then displays the requested information to the user.

For a smooth and flawless experience and surfing, specific programming languages can be used to develop the web application. Some of them are: Python, Javascript, Java, PHP, Swift, Kotlin and Ruby.

In theoretical terms, a mobile application is a software application designed to deliver services run on mobile. When compared, there is not much difference between a mobile application and a web application. Their role is the same. Display content to the user, deliver optimized responses tailored to their request and provide a seamless browsing experience. However, there is one difference. A major one. Mobile applications are specifically designed for mobile use alone. Unlike web applications which can be browsed via any browser on desktop or mobile, mobile applications can only be installed on mobile and only be browsed through them.

Mobile applications tend to lead faster and give the user a more sophisticated feel of browsing for the users. They also use less internet and work in the following way: The user downloads the application from the app store if using iPhones or the google play store if using android phones. To download the application requires a certain amount of data and storage space. After making sure that the mobile has enough space to accommodate the application, the download process starts. After downloading, the user is asked for login details or signs up before accessing the applications. Finally, the application is ready to display its content and deliver its services while also providing an enhanced user experience.

Mobile applications have a vivid and interactive UI and deliver an optimal performance tailored to user interests. The following are the programming languages that can be used for developing mobile applications: Python, HTML, CSS, Javascript, Java, Kotlin, C++, Swift, C# and Dart.

While a platform of a virtual system and a real system based on virtual configuration is disclosed, other number of combinations or partial combinations are also possible. For example, other platforms may be implemented based on one or more features presented above without deviating from the spirit of the present disclosure.

The techniques described herein can be particularly useful for one or more LEDs. While particular embodiments are described in terms of one or more LEDs, the techniques described herein are not limited to such lights but can also be used with other light types both implemented in hardware or software.

While embodiments of the present disclosure have been disclosed in exemplary forms, it will be apparent to those skilled in the art that many modifications, additions, and deletions can be made therein without departing from the spirit and scope of the disclosure and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the disclosure has been described with reference to specific embodiments. However, one of ordinary skill in the art appreciates that various modifications and changes can be made without departing from the scope of the disclosure. Accordingly, the specification and figures are to be regarded in an illustrative rather than a restrictive sense, and all such modifications are intended to be included within the scope of disclosure.

Although the disclosure has been described with respect to specific embodiments thereof, these embodiments are merely illustrative, and not restrictive of the disclosure. The description herein of illustrated embodiments of the disclosure is not intended to be exhaustive or to limit the disclosure to the precise forms disclosed herein (and in particular, the inclusion of any particular embodiment, feature or function is not intended to limit the scope of the disclosure to such embodiment, feature or function). Rather, the description is intended to describe illustrative embodiments, features and functions in order to provide a person of ordinary skill in the art context to understand the disclosure without limiting the disclosure to any particularly described embodiment, feature or function. While specific embodiments of, and examples for, the disclosure are described herein for illustrative purposes only, various equivalent modifications are possible within the spirit and scope of the disclosure, as those skilled in the relevant art will recognize and appreciate. As indicated, these modifications may be made to the disclosure in light of the foregoing description of illustrated embodiments of the disclosure and are to be included within the spirit and scope of the disclosure. Thus, while the disclosure has been described herein with reference to particular embodiments thereof, a latitude of modification, various changes and substitutions are intended in the foregoing disclosures, and it will be appreciated that in some instances some features of embodiments of the disclosure will be employed without a corresponding use of other features without departing from the scope and spirit of the disclosure as set forth. Therefore, many modifications may be made to adapt a particular situation or material to the essential scope and spirit of the disclosure.

Respective appearances of the phrases "in one embodiment," "in an embodiment," or "in a specific embodiment" or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the disclosure.

In the description herein, numerous specific details are provided, such as examples of components and/or methods, to provide a thorough understanding of embodiments of the disclosure. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the disclosure. While the disclosure may be illustrated by using a particular embodiment, this is not and does not limit the disclosure to any particular embodiment and a person of ordinary skill in the art will recognize that additional embodiments are readily understandable and are a part of this disclosure.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. An Electric Vehicle (EV) charger or electric vehicle supply equipment (EVSE), comprising:
one or more electric vehicle supply equipment (EVSE) display screens;
one or more Light Emitting Diodes (LEDs);
a processor; and
a memory storing machine executable instructions, the machine executable instructions when executed by the processor, cause the processor to perform operations, the operations comprising: lighting the screens and LEDs,
wherein a customer configurable electric vehicle supply equipment (EVSE) user interface as an application (App) that runs on a cellphone or a WebApp that runs on a server, which allows a customer to generate an EV charger configuration file that includes images loaded into different EVSE display screens, as well as to configure the behavior (colors, blinking rate, intensity) of the LEDs present at the EV charger or the EVSE.

2. The Electric Vehicle (EV) charger or electric vehicle supply equipment (EVSE) of claim 1, wherein a process of customizing images and illumination is automated and allows customers to preview how a change would look like before it takes place in a customer-controlled environment.

3. The Electric Vehicle (EV) charger or electric vehicle supply equipment (EVSE) of claim 1, wherein a mechanism is provided to allow the customer to preview how the images will look like virtually and also a mechanism is provided to configure the LEDs/illumination behavior in the Electric Vehicle (EV) charger or electric vehicle supply equipment (EVSE).

4. The Electric Vehicle (EV) charger or electric vehicle supply equipment (EVSE) of claim 1, wherein the App/WebApp allows the customer to:
a) create a target configuration,
b) simulate the look and feel of each screen on the EV charger with relevant customer images, and
c) save the target configuration as a real charger configuration for a customer group.

5. The Electric Vehicle (EV) charger or electric vehicle supply equipment (EVSE) of claim 4, whereinthe real charger configuration is then loaded into the customer group in an EVSE management system and loaded into all EV chargers/EVSEs that are associated to the EVSE management system.

6. The Electric Vehicle (EV) charger or electric vehicle supply equipment (EVSE) of claim 5, whereina custom configuration message is then sent to all the EV chargers/EVSEs at a relevant group by the EVSE management system, ensuring that all the EV chargers/EVSEs have a proper configuration of images and LED behavior.

7. The Electric Vehicle (EV) charger or electric vehicle supply equipment (EVSE) of claim 6, whereinon the EV charger/EVSE itself, the images and LED configurations are applied.

8. The Electric Vehicle (EV) charger or electric vehicle supply equipment (EVSE) of claim 1, whereina control mechanism to make their custom visualization accessible and prevent them from creating broken experiences such that colors and contrasts of foreground and background will be checked to have at least a ratio of 1:4.5 (WCGA AA standards).

9. The Electric Vehicle (EV) charger or electric vehicle supply equipment (EVSE) of claim 1, whereina platform allows visualization/simulation of changes before they take effect and allows the customer to load these changes in self-service manner directly into EV chargers/EVSEs in relevant controlled groups, allowing customers to differentiate and possibly rebrand, without any manual interaction, and without custom firmware.

10. The Electric Vehicle (EV) charger or electric vehicle supply equipment (EVSE) of claim 1, wherein aplatform allows remote simulation and configuration of a charger user interface that would be directly applied to an EV charger/EVSE.

11. A method of providing an Electric Vehicle (EV) charger or electric vehicle supply equipment (EVSE), the method comprising:
providing one or more electric vehicle supply equipment (EVSE) display screens;
providing one or more Light Emitting Diodes (LEDs);
providing a processor; and
providing a memory storing machine executable instructions, the machine executable instructions when executed by the processor, cause the processor to perform operations, the operations comprising: lighting the screens and LEDs,
wherein a customer configurable electric vehicle supply equipment (EVSE) user interface as an application (App) that runs on a cellphone or a Web App that runs on a server, which allows a customer to generate an EV charger configuration file that includes images loaded into different EVSE display screens, as well as to configure the behavior (colors, blinking rate, intensity) of the LEDs present at the EV charger or the EVSE.

12. The method of claim 11, wherein a process of customizing images and illumination is automated and allows customers to preview how a change would look like before it takes place in a customer- controlled environment.

13. The method of claim 11, wherein a mechanism is provided to allow the customer to preview how the images will look like virtually and also a mechanism is provided to configure the LEDs/illumination behavior in the Electric Vehicle (EV) charger or electric vehicle supply equipment (EVSE).

14. The method of claim 11, wherein the App/Web App allows the customer to:
a) create a target configuration,
b) simulate the look and feel of each screen on the EV charger with relevant customer images, and
c) save the target configuration as a real charger configuration for a customer group.

15. The method of claim 14, whereinthe real charger configuration is then loaded into the customer group in an EVSE management system and loaded into all EV chargers/EVSEs that are associated to the EVSE management system.

16. The method of claim 15, whereina custom configuration message is then sent to all the EV chargers/EVSEs at a relevant group by the EVSE management system, ensuring that all the EV chargers/EVSEs have a proper configuration of images and LED behavior.

17. The method of claim 16, whereinon the EV charger/EVSE itself, the images and LED configurations are applied.

18. The method of claim 11, whereina control mechanism to make their custom visualization accessible and prevent them from creating broken experiences such that colors and contrasts of foreground and background will be checked to have at least a ratio of 1:4.5 (WCGA AA standards).

19. The method of claim 11, whereina platform allows visualization/simulation of changes before they take effect and allows the customer to load these changes in self-service manner directly into EV chargers/EVSEs in relevant controlled groups, allowing customers to differentiate and possibly rebrand, without any manual interaction, and without custom firmware.

20. The method of claim 11, wherein aplatform allows remote simulation and configuration of a charger user interface that would be directly applied to an EV charger/EVSE.
